(19) United States
(12) Patent Application Publication
(10) Pub. No.: US 2010/0176651 A1
(43) Pub. Date: Jul. 15, 2010

(54) VEHICLE WHEEL ASSEMBLY AND SYSTEM

(75) Inventors: Freeman Thomas, Laguna Beach, CA (US); Gregory Hutting, Rancho Santa Margarita, CA (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/351,431

(22) Filed: Jan. 9, 2009

(51) Int. Cl. B60B 19/00

(52) U.S. Cl. 301/6.8

(57) ABSTRACT

A vehicle wheel assembly for a four-wheeled vehicle having a passenger compartment is provided. A vehicle wheel is adapted to be mounted to the four-wheeled vehicle for rotation about an axis. A disc ring is mounted to the vehicle wheel for rotation with the vehicle wheel. A caliper is adapted to be mounted to the four-wheeled vehicle radially inward from the disc ring to selectively contact the disc ring and impede rotation thereof. A vehicle wheel system may be provided with a pair of vehicle wheels, a pair of disc rings and a pair of calipers. A vehicle wheel system may be provided with a second pair of vehicle wheels, a second pair of disc rings and a second pair of calipers.

### BACKGROUND

1. Technical Field

The multiple embodiments disclosed relate to an automotive vehicle wheel assembly and system.

2. Background Art

An automotive vehicle system is typically includes four-wheel assemblies. Two of the four-wheel assemblies are typically aligned along a front axis and the other two of the four-wheel assemblies are typically aligned along a rear axis. To impede rotation of each wheel of the wheel assemblies, separate brake assemblies are mounted proximate to each of the wheel assemblies.

Often, disc brakes are employed as the separate brake assemblies. A conventional disc brake has a rotor shaped like a disc that is mounted on the axle and a caliper provided radially outward from the rotor. To impede rotation of the wheel, brake pads mounted on the caliper are forced mechanically, hydraulically, pneumatically or electromagnetically against the opposing sides of the rotor. Friction then causes the rotor, the axle and the attached wheel to slow or stop.

Conventional calipers for automotive vehicles are large in size, which results in increased material costs. Additionally, the large calipers are heavy, which increases the total weight for the automotive vehicle to increase fuel costs for the automotive vehicle. The large calipers are also inefficient because contact area between the calipers and the rotor are small. The inefficiency of the large calipers are evident because of the large amount of heat produced by the calipers during use.

Some straddle-type vehicles employ calipers radially inward from rotors.

### SUMMARY

In one embodiment, a vehicle wheel assembly for a four-wheeled vehicle having a passenger compartment is provided. A vehicle wheel is adapted to be mounted to the four-wheeled vehicle for rotation about an axis. A disc ring is mounted to the vehicle wheel for rotation with the vehicle wheel. A caliper is adapted to be mounted to the four-wheeled vehicle radially inward from the disc ring to selectively contact the disc ring and impede rotation thereof.

In a further embodiment, the disc ring further defines a plurality of mounting apertures sized to each receive a fastener to mount the disc ring to the vehicle wheel.

In another further embodiment, an inner rim is sized to receive a vehicle tire. A mounting tab extends radially inward from the inner rim and defines a plurality of receiving apertures each sized to receive the fastener to mount the disc ring to the vehicle wheel.

In yet another further embodiment, the disc ring is spaced apart from a center of the vehicle wheel.

In still another further embodiment, the caliper further comprises a first brake pad provided on a first side of the disc ring. A second brake pad is provided on a second side of the disc ring. The first brake pad and the second brake pad each selectively contact the disc ring to impede rotation thereof.

In another further embodiment, the disc ring further defines a plurality of vent apertures to cool the disc ring while contacting the caliper.

In still another further embodiment, the caliper further comprises at least one piston mounted within caliper for actuation thereof so that the caliper contacts the disc ring to impede rotation thereof.

In another embodiment, a vehicle wheel system for a four-wheeled vehicle is disclosed. A pair of vehicle wheels are adapted to be mounted to the four-wheeled vehicle for rotation about an axis. A pair of disc rings are individually mounted to one of the pair of vehicle wheels for rotation with the pair of vehicle wheels. A pair of calipers are individually adapted to be mounted to the four-wheeled vehicle radially inward from one of the pair of disc rings to each selectively contact the pair of disc rings and impede rotation thereof.

In a further embodiment, each of the pair of disc rings further defines a plurality of mounting apertures each sized to receive a fastener to mount the pair of disc rings to the pair of the vehicle wheels.

In another further embodiment, each of the pair of vehicle wheels further comprises an inner rim sized to receive a vehicle tire. A mounting tab is provided extending radially inward from the inner rim and defining a plurality of receiving apertures sized to receive the fastener to mount the pair of disc rings to the pair of the vehicle wheels.

In yet another further embodiment, each of the pair of disc rings is spaced apart from a center of the respective vehicle wheel of the pair of vehicle wheels.

In still another further embodiment, each of the pair of calipers further comprises a first brake pad provided on a first side of the disc ring. A second brake pad is provided on a second side of the disc ring. The first brake pad and the second brake pad selectively contact the pair of disc rings to impede rotation thereof.

In another further embodiment, each of the pair of disc rings further defines a plurality of vent apertures to cool each of the pair of disc rings while contacting the pair of calipers.

In yet another further embodiment, each of the pair of calipers further comprises at least one piston mounted within each caliper for actuation thereof so that each caliper contacts the disc ring to impede rotation thereof.

In another embodiment, a vehicle wheel system for a four-wheeled vehicle is provided. A first pair of vehicle wheels is adapted to be mounted to the four-wheeled vehicle for rotation about a first axis. A first pair of disc rings is individually mounted to the vehicle wheel of each of the first pair of vehicle wheels for rotation with the first pair of vehicle wheels. A first pair of calipers is individually adapted to be mounted to the four-wheeled vehicle radially inward from the disc rings of the first pair of disc rings to each selectively contact the first pair of disc rings and impede rotation thereof. A second pair of vehicle wheels is adapted to be mounted to the four-wheeled vehicle for rotation about a second axis. A second pair of disc rings is individually mounted to the vehicle wheel of each of the second pair of vehicle wheels for rotation with the second pair of vehicle wheels. A second pair of calipers is individually adapted to be mounted to the four-wheeled vehicle radially inward the disc rings of the second pair of disc rings to each selectively contact the second pair of disc rings and impede rotation thereof.

In a further embodiment, each of the first and second pairs of disc rings further define a plurality of mounting apertures each sized to receive a fastener to mount the first pair of disc rings to the first pair of the vehicle wheels and the second pair of disc rings to the second pair of the vehicle wheels.

In another further embodiment, each of the first and second pairs of vehicle wheels further comprises an inner rim sized to receive a vehicle tire. A mounting tab is provided extending radially inward from the inner rim and defining a plurality of receiving apertures sized to receive the fastener to mount the first pair of disc rings to the first pair of the vehicle wheels and the second pair of disc rings to the second pair of the vehicle wheels.

In another further embodiment, each of the first and second pairs of disc rings is spaced apart from a center of the respective vehicle wheel of the first and second pairs of vehicle wheels.

In still another further embodiment, each of the first and second pairs of calipers further comprises a first brake pad provided on a first side of the disc ring. A second brake pad is provided on a second side of the disc ring. The first brake pad and the second brake pad selectively contact the first and second pairs of disc rings to impede rotation thereof.

In yet another further embodiment, each of the first and second pairs of calipers each further comprise at least one piston mounted within each caliper for actuation thereof so that each caliper contacts the disc ring to impede rotation thereof.

### BRIEF DESCRIPTION OF THE DRAWINGS

FIG. 1 is a schematic view of a vehicle wheel system;

FIG. 2 is a front perspective view of a vehicle wheel assembly of the vehicle wheel system of FIG. 1;

FIG. 3 is another front perspective view of a vehicle wheel assembly of the vehicle wheel system of FIG. 1; and

FIG. 4 is a cross-sectional view of the vehicle wheel assembly of FIG. 3.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

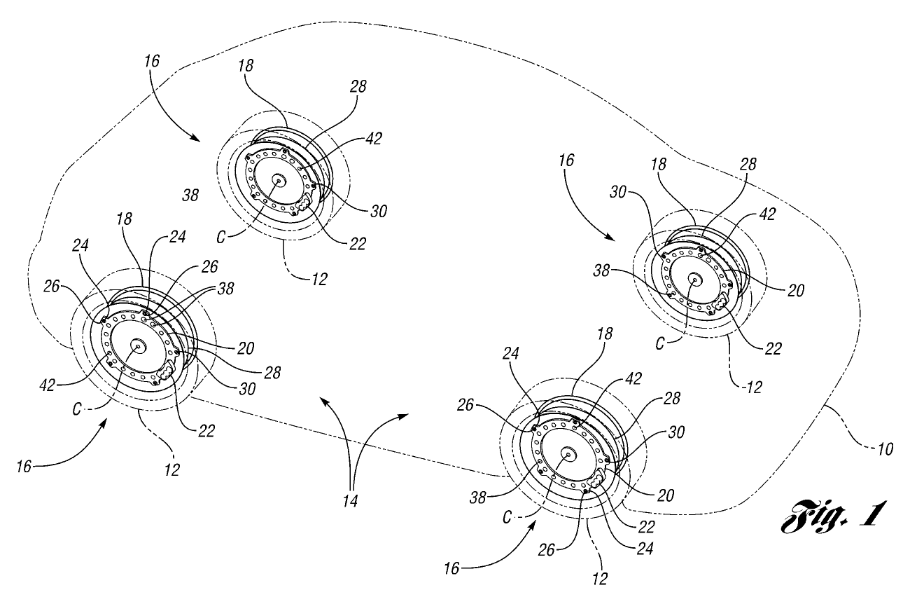

With reference to FIG. 1, an automotive vehicle is illustrated and generally referenced by numeral 10. The automotive vehicle 10 illustrated has a vehicle compartment with multiple vehicle seats, as known in the prior art, to carry multiple passengers. The vehicle 10 has four tires 12 that are mounted on a wheel system 14. The wheel system 14 is mounted to a known vehicle suspension. The suspension is mounted to a known chassis of the vehicle 10. As illustrated the wheel system 14 has four wheel assemblies 16. In another embodiment, the wheel system 14 has two wheel assemblies 16. The four tires 12 are each respectively mounted on one of the four wheel assemblies 16.

In the depicted embodiment, two front wheel assemblies 16 are each mounted toward a front of the vehicle 10. The wheel assemblies 16 may each be provided on separate vehicle suspensions and can each rotate about an axis, as known in the art. Any suitable mounting of the wheel assemblies 16 is contemplated within the scope of the disclosed embodiments. Two rear wheel assemblies 16 are each mounted toward a rear of the vehicle 10. The two wheel assemblies 16 may each be provided on separate vehicle suspensions and can each rotate about an axis, as known in the art. Any suitable mounting of the wheel assemblies 16 is contemplated within the scope of the disclosed embodiments.

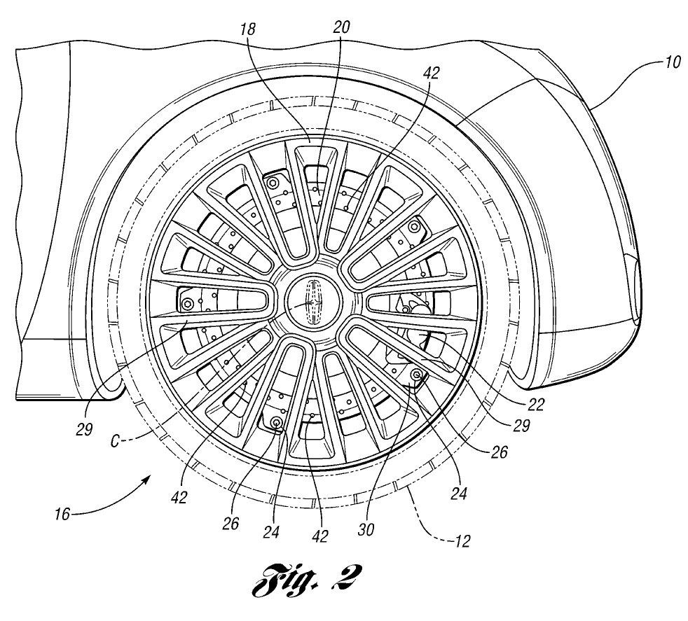

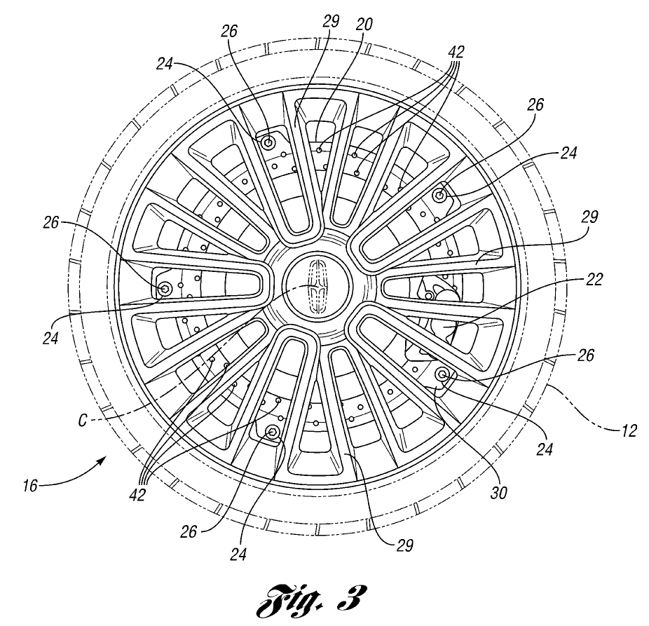

As illustrated in FIGS. 1-3, each wheel assembly 16 has a wheel 18 that supports the tire 12. The wheel 18 rotates about an axis A to rotate the tire 12, which in turn produces a rolling motion of the vehicle 10, as known in the art. The axis A generally aligns a center C of the wheel 18. Additionally, the wheel 18 can be turned to steer the vehicle 10, as known in the art.

Although the wheel 18 rotates in a known manner, the rotation of the wheel 18 is controlled by a disc ring 20 and a caliper 22. The disc ring 20 is mounted directly to the wheel 18. The caliper 22 is provided radially inward from the disc ring 20. As discussed further below, the caliper 22 is orientated across the disc ring 20 proximate to the center C of the wheel.

In prior art wheel assemblies for automotive vehicles, rotors are provided rather than the disc ring 20 disclosed herein. The prior art rotors are mounted to a hub rather than being mounted directly to the wheel. Orienting the rotor on the hub, rather than on the wheel increases time for removal of the rotor because the rotor is separately mounted from the wheel and requires a separate step for removal. The wheel assembly 16 disclosed herein has relatively quicker removal time because removal of the wheel 18 also removes the disc ring 20 that is mounted thereon.

Furthermore, since prior art rotors are mounted directly to the hub and prior art calipers are mounted radially outward of the rotor, the rotor spans from the hub to the caliper. The disc ring 20 disclosed herein is not mounted to the center C of the wheel 18.

Additionally, the disclosed herein has a reduced sized in comparison to the prior art because the caliper 22 is mounted radially inward from the disc ring 20. Decreasing the size of the caliper 22 would utilize less material than prior art calipers that are radially outward from the rotor. Utilization of less material for production of the caliper 22 decreases use of raw materials and decreases vehicle weight to decrease fuel usage and costs. Thus, the utilization of less material for the caliper 22 is also cost effective, eco-conscience and environmentally friendly.

The disc ring 20 may be made out a metal material, such as a cast iron or a gray iron. In another embodiment, the disc ring 20 is made out of lighter material than a metal such as a ceramic composite. An example of a ceramic composite includes but is not limited to a carbon fiber reinforced ceramic. Of course, any suitable metal, ceramic or other material for the disc ring 20 is contemplated within the scope of the disclosed embodiments.

As illustrated in FIGS. 1-4, the disc ring 20 has mounting apertures 24 to attach the disc ring 20 to the wheel 18. The mounting apertures 24 are formed through the disc ring 20 to each receive a fastener 26. The fasteners 26 may be screws, bolts or any suitable fasteners in order to attach the disc ring 20 to the wheel 18.

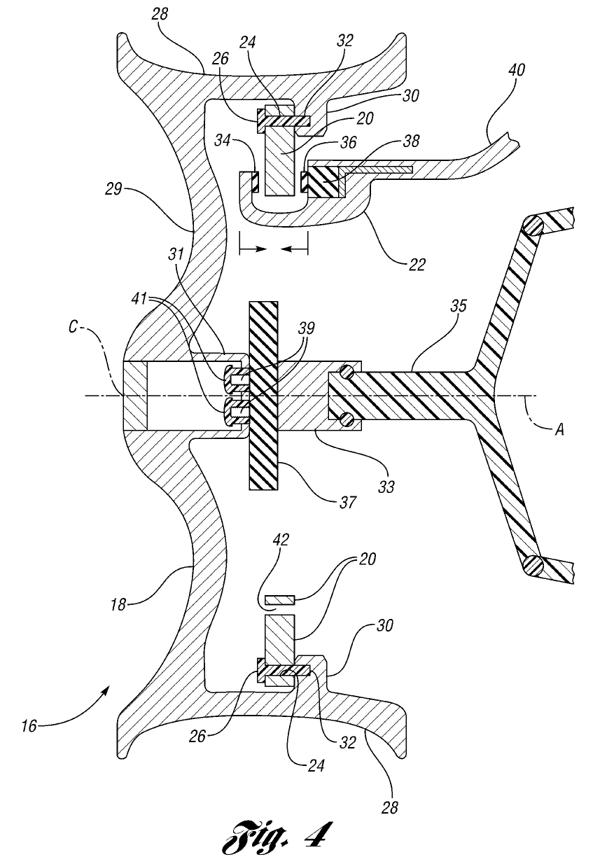

In FIG. 4, the mounting of the disc ring 20 to the wheel 18 is illustrated. The wheel 18 has an inner rim 28 and spokes 29. Extending from the inner rim 28 is a mounting tab 30. The mounting tab 30 may span the entire circumference of the inner rim 28 of the while. In another embodiment, multiple separate mounting tabs 30 extend from the inner rim 28. In the illustrated embodiment, the mounting tab 30 is integrally formed with the wheel 18. In another embodiment, the mounting tab 30 is separately formed from the wheel 18 and mounted thereon in a suitable manner.

As illustrated, the mounting tab 30 has receiving apertures 32 formed therein. The receiving apertures 32 receive the fasteners 26 that extend through the mounting apertures 24 of the disc ring 20 to connect the disc ring 20 to the wheel 18. In the depicted embodiment, the receiving apertures 32 do not extend through the mounting tab 30. In another embodiment, the receiving apertures 32 extend through the mounting tab 32 so that a nut secures the fastener 26 between the wheel 18 and the disc ring 20.

Still referring to FIG. 4, the wheel 18 is shown mounted along the axis A. The wheel 18 has a hub 31 that is mounted to an axle 33 of the vehicle 10. The axle 33 is connected to the steering armature 35 that the axle 33 is adapted to transmit both rotation and pivoting motion in order to increase wheel 18 rotation to increase vehicle speed and move alignment of the wheel 18 for vehicle steering, as known in the art. Any suitable axle 33 and steering armature 35 are contemplated within the scope of the disclosed embodiments.

As illustrated, the axle 33 has an axle flange 37 that mounts the wheel 18 to the axle 33. The axle flange 37 may have a wheel pilot, as known in the art. The axle flange 37 illustrated has studs 39 that are received by openings formed in the wheel hub 31. Lugs nuts 41 fasten the wheel 18 to the axle flange 37, as known in the art. Of course, any suitable mounting between the wheel 18 and the axle flange 37 is contemplated within the scope of the disclosed embodiments.

The wheel 18 can be removed from the axle flange 37 in any known manner. When removing the wheel 18 from the axle flange 37, the disc ring 20 is also removed. Since the disc ring 20 is attached to the wheel 18 work could performed on the disc ring 20 away from a wheel well of the vehicle 10 in a comfortable area such as on a workbench. Additionally, with the wheel 18 and the disc ring 20 removed, the caliper 22 is exposed for easy access in order for inspection and/or to change break pads 34, 36.

In the depicted embodiment, the caliper 22 is provided radially inward from the disc ring 20 because the caliper is oriented between the disc ring 20 and the center C of the wheel 18, which is along the axis A₁. In at least one embodiment, the caliper 22 is fixed relative to the disc ring 20 so that the caliper 22 is a fixed caliper. The caliper 22 may be supported by to the steering armature 35. In at least one embodiment, the caliper 22 is a floating caliper as known in the art. Any suitable caliper 22 that is provided radially inward from the disc ring 20 is contemplated within the scope of the disclosed embodiments.

As illustrated, the caliper 22 has a first brake pad 34 and a second brake pad 36. The first brake pad 34 and the second brake pad 36 are provided on opposing sides of the disc ring 20. The brake pads 34, 36 have increased sizes relative to the prior art to increase efficiency of the smaller sized caliper 22. The caliper 22 is moved by a piston 38 having an input 40 to actuate the piston 38, as known in the art. The input 40 may be mechanical, hydraulic, pneumatic or electromagnetical. Any suitable input 40 is contemplated within the scope of the disclosed embodiments.

In the depicted embodiment, the piston 38 is provided inboard relative to the vehicle 10. In another embodiment, the piston 38 is provided outboard relative to the vehicle 10. In yet another embodiment, pistons 28 are provided both inboard and outboard relative to the vehicle 10. Although a single piston 38 is illustrated, the invention contemplates alternate embodiments wherein multiple pistons 38 are provided inboard relative to the vehicle 10 and/or outboard relative to the vehicle 10. In at least one embodiment, six pistons 38 are provided so that the caliper 22 has six pots as known in the art.

The piston 38 moves the caliper 22 towards the disc ring 20, as indicated by the arrows proximate the caliper 22, which is known in the art. Upon actuation, the brake pads 34, 36 contact the disc ring 20 and cause friction between the brake pads 34, 36 and the disc ring 20 in order to slow or stop rotation of the disc ring 20, which correspondingly slows or stops rotation of the wheel 18.

The disc ring 20 may be ventilated by having a vent aperture 42. As depicted in FIGS. 1-3, the disc ring 22 may have multiple vent apertures 42. The vent apertures 42 help to dissipate heat generated by the friction caused when the caliper 22 contacts the disc ring 20. Additionally, the vent apertures 42 reduce water residue that may build up after the vehicle 10 passes through a puddle so that braking performance is not altered.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A vehicle wheel assembly for a four-wheeled vehicle having a passenger compartment comprising:
a vehicle wheel adapted to be mounted to the vehicle for rotation about an axis;
a disc ring mounted to the vehicle wheel for rotation therewith; and
a caliper adapted to be mounted to the four-wheeled vehicle radially inward from the disc ring to selectively contact the disc ring and impede rotation thereof.

2. The vehicle wheel assembly of claim 1 wherein the disc ring further defines a plurality of mounting apertures sized to each receive a fastener to mount the disc ring to the vehicle wheel.

3. The vehicle wheel assembly of claim 2 wherein the vehicle wheel further comprises:
an inner rim sized to receive a vehicle tire; and
a mounting tab extending radially inward from the inner rim and defining a plurality of receiving apertures each sized to receive the fastener to mount the disc ring to the vehicle wheel.

4. The vehicle wheel assembly of claim 1 wherein the disc ring is spaced apart from a center of the vehicle wheel.

5. The vehicle wheel assembly of claim 1 wherein the caliper further comprises:
a first brake pad provided on a first side of the disc ring;
a second brake pad provided on a second side of the disc ring;
wherein the first brake pad and the second brake pad each selectively contact the disc ring to impede rotation thereof.

6. The vehicle wheel assembly of claim 1 wherein the disc ring further defines a plurality of vent apertures to cool the disc ring while contacting the caliper.

7. The vehicle wheel assembly of claim 1 wherein the caliper further comprises at least one piston mounted within caliper for actuation thereof so that the caliper contacts the disc ring to impede rotation thereof.

8. A vehicle wheel system for a four-wheeled vehicle comprising:
a pair of vehicle wheels adapted to be mounted to the four-wheeled vehicle for rotation about an axis;
a pair of disc rings individually mounted to one of the pair of vehicle wheels for rotation with the pair of vehicle wheels; and
a pair of calipers individually adapted to be mounted to the four-wheeled vehicle radially inward from one of the pair of disc rings to each selectively contact the pair of disc rings and impede rotation thereof.

9. The vehicle wheel system of claim 8 wherein each disc ring of the pair of disc rings further defines a plurality of mounting apertures each sized to receive a fastener to mount the pair of disc rings to the pair of the vehicle wheels.

10. The vehicle wheel system of claim 9 wherein each vehicle wheel of the pair of vehicle wheels further comprises:
an inner rim sized to receive a vehicle tire; and
a mounting tab extending radially inward from the inner rim and defining a plurality of receiving apertures sized to receive the fastener to mount the pair of disc rings to the pair of the vehicle wheels.

11. The vehicle wheel system of claim 8 wherein each disc ring of the pair of disc rings is spaced apart from a center of the respective vehicle wheel of the pair of vehicle wheels.

12. The vehicle wheel system of claim 8 wherein each caliper of the pair of calipers further comprises:
a first brake pad provided on a first side of the disc ring;
a second brake pad provided on a second side of the disc ring;
wherein the first brake pad and the second brake pad selectively contact the pair of disc rings to impede rotation thereof.

13. The vehicle wheel system of claim 7 wherein each disc ring of the pair of disc rings further defines a plurality of vent apertures to cool each of the pair of disc rings while contacting the pair of calipers.

14. The vehicle wheel system of claim 7 wherein each caliper of the pair of calipers further comprise at least one piston mounted within each caliper for actuation thereof so that each caliper contacts the disc ring to impede rotation thereof.

15. A vehicle wheel system for a four-wheeled vehicle comprising:
a first pair of vehicle wheels adapted to be mounted to the four-wheeled vehicle for rotation about a first axis;
a first pair of disc rings individually mounted to the vehicle wheel of each of the first pair of vehicle wheels for rotation with the first pair of vehicle wheels;
a first pair of calipers individually adapted to be mounted to the four-wheeled vehicle radially inward from the disc rings of the first pair of disc rings to each selectively contact the first pair of disc rings and impede rotation thereof;
a second pair of vehicle wheels adapted to be mounted to the four-wheeled vehicle for rotation about a second axis;
a second pair of disc rings individually mounted to the vehicle wheel of each of the second pair of vehicle wheels for rotation with the second pair of vehicle wheels; and
a second pair of calipers individually adapted to be mounted to the four-wheeled vehicle radially inward the disc rings of the second pair of disc rings to each selectively contact the second pair of disc rings and impede rotation thereof.

16. The vehicle wheel assembly of claim 15 wherein each disc ring of the first and second pairs of disc rings further define a plurality of mounting apertures each sized to receive a fastener to mount the first pair of disc rings to the first pair of the vehicle wheels and the second pair of disc rings to the second pair of the vehicle wheels.

17. The vehicle wheel assembly of claim 16 wherein each vehicle wheel of the first and second pairs of vehicle wheels further comprises:
an inner rim sized to receive a vehicle tire; and
a mounting tab extending radially inward from the inner rim and defining a plurality of receiving apertures sized to receive the fastener to mount the first pair of disc rings to the first pair of the vehicle wheels and the second pair of disc rings to the second pair of the vehicle wheels.

18. The vehicle wheel assembly of claim 15 wherein each disc ring of the first and second pairs of disc rings is spaced apart from a center of the respective vehicle wheel of the first and second pairs of vehicle wheels.

19. The vehicle wheel assembly of claim 15 wherein each caliper of the first and second pairs of calipers further comprises:
a first brake pad provided on a first side of the disc ring;
a second brake pad provided on a second side of the disc ring;
wherein the first brake pad and the second brake pad selectively contact the first and second pairs of disc rings to impede rotation thereof.

20. The vehicle wheel assembly of claim 15 wherein each caliper of the first and second pairs of calipers each further comprise at least one piston mounted within each caliper for actuation thereof so that each caliper contacts the disc ring to impede rotation thereof.
